(19) United States
(12) Patent Application Publication
(10) Pub. No.: US 2024/0310292 A1
(43) Pub. Date: Sep. 19, 2024

(54) OBLIQUE UNIFORM ILLUMINATION FOR IMAGING SYSTEMS

(71) Applicant: KLA Corporation, Milpitas, CA (US)

(72) Inventor: Guoheng Zhao, Palo Alto, CA (US)

(21) Appl. No.: 18/434,747

(22) Filed: Feb. 6, 2024

Related U.S. Application Data
(60) Provisional application No. 63/451,928, filed on Mar. 14, 2023.

(51) Int. Cl. G01N 21/88; H04N 23/56

(52) U.S. Cl. CPC G01N 21/8806; H04N 23/56; G01N 2201/0638

(57) ABSTRACT

Methods and systems for generating an image of a specimen are provided. One system includes an axial diffractive optical element (DOE) positioned in a beam of light generated by a light source. The beam of light is offset to a center of the axial DOE. The axial DOE includes concentric grating rings configured to separate the beam of light into multiple beams. In addition, the system includes focusing optics configured to focus the multiple light beams to multiple spots, respectively, on a specimen. A common focal plane of the multiple spots is at a tilted angle with respect to an optical axis of the focusing optics. The system also includes an imaging detector configured to generate an image of the specimen by detecting light from the multiple spots.

### BACKGROUND OF THE INVENTION

### 1. Field of the Invention

This invention generally relates to methods and systems for oblique uniform illumination for imaging systems. Certain embodiments relate to providing substantially uniform flattop illumination profiles via obliquely illuminated spots.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a photomask to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

The configuration of inspection systems can dramatically affect the capability of the tools especially as the structures on the specimens being inspected become much smaller and more complex and/or as the particles or defects on the specimens become significantly smaller. Although nearly every configurable parameter of an inspection system may have an effect on the inspection capability of the system, the primary concern addressed herein is the illumination configuration and how its various parameters can affect inspection performance.

Some currently used inspection systems are configured for generating a flat top illumination profile to provide uniformity of the illumination intensity across the illuminated area on the specimen. Some such systems use a wavefront phase transformation to convert a Gaussian beam shape to a top hat beam profile shape. These methods are fairly old with many commercially available parts. There are typically two methods in this category. The optical element of wavefront transformation can be refractive elements or a diffractive element. The refractive elements typically are aspheric lenses, which are commercially available.

Other currently used systems combine multiple Gaussian beams to generate a flattop. The multiple Gaussian beams have to be from a single laser so they are coherent. To avoid the interference between spots (which degrade uniformity), the spots can be either separated in spatial domain or in time domain. Spots separated in time domain can be partially overlapped to make up a flat top without interference fringes if optical path length differences between spots are greater than the coherent length. Typical coherent length of mode locking (ML) laser is a few millimeters. Spots separated in the spatial domain rely on the integration of time delay integration (TDI) scan to merge the spots in one dimension to produce a uniform flat top in the orthogonal direction.

The main challenge of the time domain separation method is how to recombine the beams. For wafer inspection, each of the multiple beams needs to be nearly co-linear through the illumination path and focused on nearly the same location on the wafer, due to the limitations on illumination numerical aperture (NA), e.g., substantially small, and illumination field size (also substantially small compared to input beam diameter). Theoretically, this is a very straightforward concept, but implementation is extremely difficult, because of the tight requirements on stability and alignment tolerance.

The method of converting Gaussian beam directly to a flat top illumination profile, regardless of the methods (refractive or diffractive), have a number of important disadvantages. The main disadvantage is that the output flattop is sensitive to input beam quality and alignment. Relatively small changes of input beam wavefront, beam size, or misalignment can degrade greatly output uniformity.

Wafer inspection systems employ oblique illumination for optimum defect detection sensitivity. The angle of oblique illumination is defined by two parameters: polar angle and azimuthal angle. Polar angle and azimuthal angle are defined by the coordinate system of wafer surface (xy plane) and scan direction (x axis). Wafer surface normal is the z axis. For best particle detection sensitivity, polar angle of illumination is between 60 degrees and 80 degrees. At such large polar angle, the projected beam size is elongated by a factor of 1/cos(polar angle) which can be between 2× to 6×. When the elongation is in the scan direction (90 degree azimuthal angle), a larger TDI sensor size is required to cover the elongated illumination field. Multiple azimuthal illumination angles can reduce speckle noise therefore improve defect sensitivity. For dual azimuthal angle illuminations, +/−45 degree oblique illumination angles are more advantageous than currently used 0/90 azimuth illumination because of symmetrical optics and a good compromise of steep oblique factors. There is also no proven good solution for 45 degree azimuthal oblique illumination.

Accordingly, it would be advantageous to develop imaging systems and/or methods that do not have one or more of the disadvantages described above.

### SUMMARY OF THE INVENTION

The following description of various embodiments is not to be construed in any way as limiting the subject matter of the appended claims.

One embodiment relates to a system configured for generating an image of a specimen. The system includes a light source configured to generate a beam of light. The system also includes an axial diffractive optical element (DOE) positioned in the beam of light. The beam of light is offset to a center of the axial DOE. The axial DOE includes concentric grating rings configured to separate the beam of light into multiple light beams. In addition, the system includes focusing optics configured to focus the multiple light beams to multiple spots, respectively, on a specimen. A common focal plane of the multiple spots is at a tilted angle with respect to an optical axis of the focusing optics. The system further includes an imaging detector configured to generate an image of the specimen by detecting light from the multiple spots. The system may be further configured as described herein.

Another embodiment relates to a method for generating an image of a specimen. The method includes separating a beam of light into multiple light beams with an axial DOE positioned in the beam of light. The beam of light is offset to a center of the axial DOE. The axial DOE includes concentric grating rings configured to separate the beam of light into the multiple light beams. The method also includes focusing the multiple light beams to multiple spots, respectively, on a specimen. A common focal plane of the multiple spots is at a tilted angle with respect to an optical axis of the multiple light beams. In addition, the method includes generating an image of the specimen by detecting light from the multiple spots.

The steps of the method may be performed as described further herein. In addition, the method may include any other step(s) of any other method(s) described herein. The method may be performed by any of the systems described herein.

An additional embodiment relates to a system configured for inspecting a specimen. The system includes the light source, axial DOE, focusing optics, and imaging detector described above. The system also includes a computer subsystem configured to detect defects on the specimen based on the image. The system may be configured as described further herein.

### BRIEF DESCRIPTION OF THE DRAWINGS

Other objects and advantages of the invention will become apparent upon reading the following detailed description and upon reference to the accompanying drawings in which:

FIG. 1 is a schematic diagram illustrating a side view of an example of a previously used diffractive optical element (DOE) and an embodiment of an axial DOE that illustrates the principle of using an axial grating beam splitter to generate a spot array at a slant angle;

FIG. 2 is a schematic diagram illustrating a plan view of an embodiment of design parameters of using multiple spots and time delay integration (TDI) to generate a uniform top-hat illumination profile;

FIG. 3 is a schematic diagram illustrating a plan view of an embodiment of a spot array layout of 9 spots;

FIG. 4 is a plot illustrating the effective intensity profile from TDI integration of the 9 spots in the layout shown in FIG. 3;

FIG. 5 is a schematic diagram illustrating a side view of design parameters of an embodiment of an axial DOE and focusing lens for generating a slanted spot array;

FIG. 6a is a schematic diagram illustrating a top view (from the specimen surface) of an embodiment of an illumination beam path;

FIG. 6b is a schematic diagram illustrating a side view of the illumination beam path of FIG. 6a;

FIG. 7 is a schematic diagram illustrating an embodiment of angles defining incident plane, spot array angle, and illumination angle of incidence;

FIG. 8 is a schematic diagram illustrating a side view of one embodiment of elements for transforming and delivering a single laser beam to a slanted spot array on a specimen surface;

FIG. 9 is a schematic diagram illustrating a plan view of one example of a definition of azimuthal angles of illumination;

FIG. 10 is a schematic diagram illustrating a side view of one embodiment of a system configured for generating an image of a specimen and/or for inspecting the specimen; and

FIG. 11 is a block diagram illustrating one embodiment of a non-transitory computer-readable medium storing program instructions executable on a computer system for performing one or more of the computer-implemented methods described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

The embodiments described herein generally relate to methods and systems for generating an image of a specimen. The embodiments described herein are particularly advantageous for oblique uniform illumination for imaging systems. In addition, the embodiments described herein provide oblique uniform illumination for laser scan, time delay integration (TDI) imaging systems. For example, the embodiments described herein advantageously provide methods and systems for generating flat top illumination for oblique laser dark field (DF) wafer inspection. (The terms “flat top,” “flattop,” “top-hat,” and “top hat” are used interchangeably herein to all mean an intensity profile that has a generally step function type shape, as opposed to other intensity profile shapes or functions such as Gaussian.) However, the illumination configurations described herein may be included in any suitable imaging system known in the art.

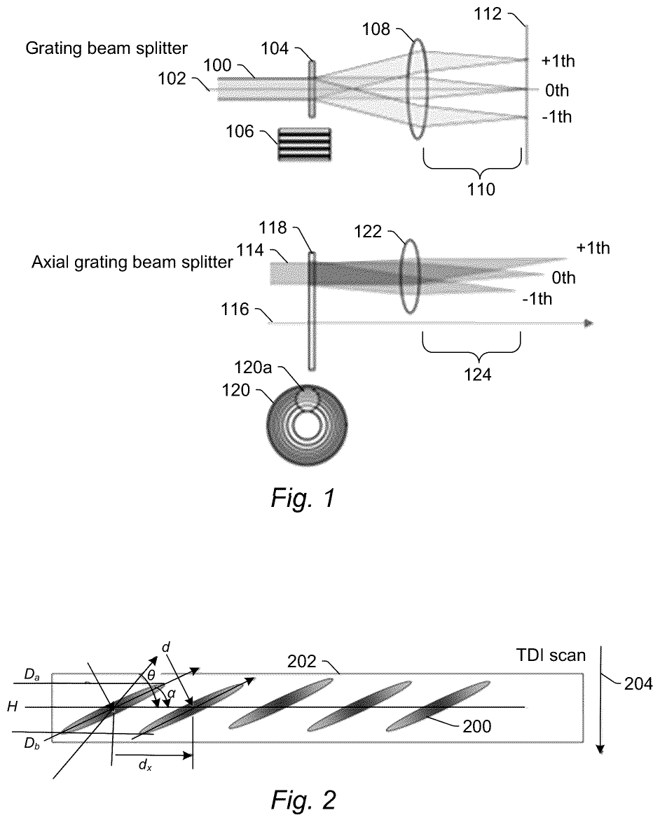

FIG. 1 shows the fundamental working principle of the embodiments described herein. Two types of beam splitting diffractive optical elements (DOEs) are compared to demonstrate how to generate a one-dimensional (1D) spot array that has a focal plane at a slanted (i.e., non-perpendicular) angle with respect to the optical axis. More specifically, this figure shows the principle of using an axial grating beam splitter to generate a spot array at a slant angle. The terms “axial DOE,” “axial grating,” “axial grating beam splitter,” and “off-axis DOE” are used interchangeably herein.

Currently used grating beam splitter 104 splits collimated input beam 100 into multiple collimated beams 110 (3 beams shown here), and focusing lens 108 focuses the three beams into 3 spots. Common focal plane 112 of the focused spots is perpendicular to optical axis 102 of collimated input beam 100 and focusing lens 108. As shown in cross-sectional view 106 of grating beam splitter 104, the beam splitter may include parallel grating lines that separate the beam of light into multiple light beams.

In the embodiments described herein, a beam is split by an axial DOE. The system includes axial DOE 118 positioned in beam of light 114. In one embodiment, the axial DOE is configured to function as a combination of a diffractive beam splitter and a Fresnel lens with a weak focusing power of diffraction orders. In other words, the axial DOE functions similar to a Fresnel lens but has substantially weak focusing power of diffraction orders. For example, axial grating 118 (which is configured for performing a combination of functions of beam splitter grating and Fresnel lens) splits collimated beam 114 into multiple beams 124 (3 beams are shown although the light beam may be split into any suitable number of beams).

As shown in cross-sectional view 120 of axial grating 118, the axial DOE includes concentric grating rings configured to separate the beam of light into multiple light beams. The layout of the concentric rings may be the same as a conventional Fresnel Zone Plate (FZP). However, the grating profile is designed to generate multiple uniform diffraction orders as opposed to only one diffraction order of the conventional FZP. Therefore such a DOE combines the functions of a FZP and a beam splitter. The axial DOE has the same grating groove layout of a FZP and the same grating groove profile of a diffractive beam splitter. Like the focusing power of FZP, the axial DOE also generates focusing power of the multiple diffraction orders. The focusing power is proportional to the order of diffractions so positive orders are converging and negative orders are diverging. The axial DOE is designed such that the focusing power of all orders are substantially small with focal lengths of many meters, which is how a “substantially weak focusing power” can be defined in the embodiments described herein. In one embodiment, at least two of the multiple light beams have different powers. For example, each split beam has a slightly different power, and when focused by a focusing lens as described herein, the beams form an array of spots of having a common focal plane at an oblique angle to the incident beam.

As shown in FIG. 1, beam of light 114 is offset to a center of the axial DOE. For example, axis 116 through the center of the axial DOE is offset from light beam 114. This offset is further shown in cross-sectional view 120 in which the position of the light beam cross-section 120a is offset from the center of the axial DOE (where the center of the DOE is defined by the center of curvature of the DOE grating grooves). In this manner, the axial DOE is used at an off-axis position, that is, the laser beam only uses the portion of the DOE that is away from its optical axis. In one embodiment, a pitch of the grating rings varies with a radius of the axial DOE. In this manner, the DOE includes concentric grating rings, and a pitch of the grating varies with radius of the DOE. For example, as shown in cross-sectional view 120 of axial DOE 118, the pitch of the grating rings changes across a radius of the axial DOE. The axial DOE may be further configured as described in U.S. Pat. No. 9,945,792 to Zhao issued Apr. 17, 2018, which is incorporated by reference as if fully set forth herein.

Focusing optics (focusing lens 122 shown in FIG. 1) are configured to focus multiple light beams 124 generated by the axial DOE to multiple spots, respectively, on a specimen (not shown in FIG. 1). As shown in FIG. 1 and other figures described herein, the focusing lens may be positioned on-axis, meaning on the same optical axis of the incoming light beam and any other illumination optics. The focusing lens and any other focusing optics described herein may have any suitable configuration known in the art.

A common focal plane of the multiple spots is at a tilted angle with respect to an optical axis of the focusing optics. In addition, the embodiments described herein can generate a spot array at an arbitrary angle with respect to the illumination beam. In other words, the spot array line may be at an angle with the incident direction, and the spot line angle may be controlled by the DOE de-centering relative to the light beam and the optical axis of the illumination optics. For example, when the input beam is offset to the center of the axial DOE as shown in FIG. 1, and the beams are focused by a focusing lens, the focus of each beam (the longitudinal position of each spot) is located at a different distance from the focus lens. In particular, as shown in FIG. 1, the focal points of each of beams 124 are located at a different distance from focusing lens 122. The common focal plane of all spots hence is at a tilted angle with respect to the optical axis of the focusing lens. For example, in FIG. 1, if a plane is drawn in which all the focal points of multiple beams 124 are located, that common focal plane is at a tilted angle with respect to the optical axis of focusing lens 122. In other words, the common focal plane is not perpendicular to the optical axis of the focusing lens.

In principle, therefore, a linear spot array can be generated at a tilt angle with an off-axis axial DOE and a focusing lens, which is the first step of generating a flattop profile from a spot array. In some embodiments, the multiple spots have an elliptical shape with a long axis at an angle with respect to a scan direction of the imaging detector. For example, as shown in FIG. 2, each of illuminated spots 200 on a specimen (not shown in FIG. 2) has an elliptical shape. To form an effectively uniform flat top illumination profile, the spot shape is elongated and slanted with respect to TDI integration (scan) direction 204, as shown in FIG. 2. In other words, the long axis of each elliptically shaped spot is not parallel or perpendicular to the scan direction of the imaging detector. Instead, the spots have elliptical shape, and the long axis of the elliptical spots has an angle with respect to the TDI scan direction.

FIG. 2 also shows the design parameters of using multiple spots and TDI integration to generate a uniform top-hat illumination profile. In one embodiment, the imaging detector is configured as a TDI camera (also simply referred to herein as a TDI and a TDI sensor). In one such embodiment, projection of each of the multiple spots onto a field direction of the TDI camera, perpendicular to a scan direction of the TDI camera, overlaps with projection of one or more of the multiple spots adjacent to each of the multiple spots onto the field direction. In other words, the projection of the elliptical spots onto the TDI field direction (perpendicular to the TDI scan direction) overlaps with the projection of their respective adjacent spots onto the TDI field direction. For example, in FIG. 2, a field direction of the TDI camera is perpendicular to scan direction 204 of the TDI camera. Projection of each of multiple spots 200 (in this case 5 spots, but any other number of spots may be used as well) onto a field direction of a TDI camera (not shown in FIG. 2), which is perpendicular to scan direction 204, will overlap with projection(s) of light from their adjacent spot(s). In other words, if the multiple spots are projected from a specimen onto field 202 of the TDI and then are projected (i.e., flattened) onto the line H shown in FIG. 2, the light from adjacent spots would overlap along that line.

In an embodiment, the multiple spots are separated from each other on the specimen. In this manner, each of the spots are separated in spatial domain. In other words, the spots as illuminated on the specimen (and therefore in the common focal plane of the spot array) are spatially separated from each other. In particular, no portion of any one spot overlaps on the specimen with any other spot on the specimen. The spots may be spatially separated to avoid interference between adjacent spots. However, in one embodiment, a projected distance between each of the multiple spots and each of the one or more of the multiple spots adjacent to each of the multiple spots is approximately half a size of the multiple spots. In other words, the projected distance between adjacent spots is approximately half of the spot size. In this manner, although the spots are separated in the spatial domain on the specimen, approximately one half of a projection of a first spot may overlap with approximately one half of a projection of a spot adjacent to it. To put it another way, a distance between the centers of the projections between two adjacent spots along the field direction of the TDI may be approximately one half the size of the multiple spots in that direction.

In another embodiment, the imaging detector is configured to integrate intensity of the light from the multiple spots in the scan direction. In an additional embodiment, a projected overlap of the multiple spots generates a uniform flattop illumination profile. The term “uniform flattop illumination profile” as used herein is generally defined as an illumination profile that has substantially the same values of intensity (i.e., statistically the same values of intensity) across an entire dimension (or nearly all of an entire dimension) of the illumination area. For example, TDI integration may sum the energy in scan direction 204 to form effectively a flattop intensity profile. Therefore, although the spots are separated in the spatial domain, the integration of the TDI scan can merge the spots in one dimension to produce a substantially uniform flat top in the orthogonal direction. In this manner, the TDI scan integrates the illumination intensity in the scan direction, and the projected overlap of adjacent spots generates a substantially uniform flattop illumination profile.

Each spot is defined by the spot size in long (Dₐ) and short (D_{b}) directions, and the orientation angle α. The flattop efficiency is defined by the usable power within the flat portion of the illumination profile, approximately given by:

$$η ∼ \frac{N - 1}{N}$$

The conditions for forming a uniform flattop area as follows:

$$\begin{matrix}{D}_{a} < \frac{1}{2} \frac{F}{N - 1} sin α \\ {D}_{b} > \frac{2 F}{N - 1} \frac{1}{cos α}\end{matrix}$$

where F is the field size.

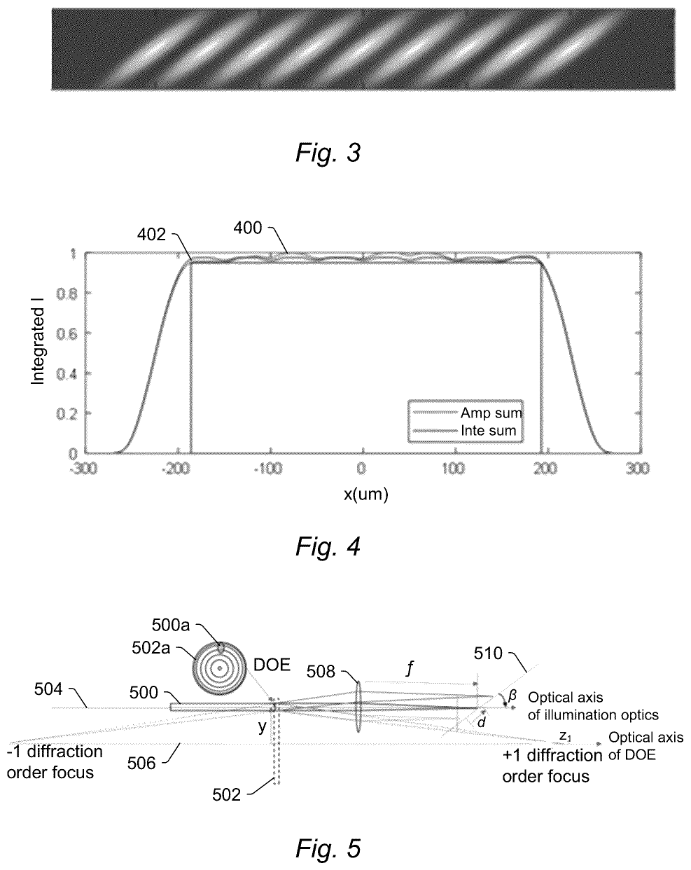

FIG. 3 illustrates an embodiment of a spot array layout of 9 spots. The integrated intensity profile, sum of electric field amplitude including a random phase offset between spots, is shown in FIG. 4. More specifically, FIG. 4 shows the effective intensity profile from TDI integration of the 9 spot layout shown in FIG. 3. As shown in FIG. 4, both the amplitude sum plot 400 and intensity sum plot 402 have approximately a flattop intensity profile.

FIG. 5 shows the critical design parameters and how they are determined. More specifically, FIG. 5 shows the design parameters of an axial DOE and focusing lens for generating a slanted spot array. As shown in this figure, light beam 500 is directed to axial DOE 502, which is shown in cross-sectional view 502a. The beam of light is offset to a center of the axial DOE. For example, as shown in FIG. 5, optical axis of illumination optics 504 on which the beam of light is centered is offset from optical axis of DOE 506. In this manner, the center of the light beam and the center of the axial DOE are offset from each other. This offset is further shown in cross-sectional view 502a of axial DOE 502, on which cross-sectional view 500a of the light beam is overlapped to show the offset of the light beam from the center of the axial DOE. The axial DOE may be further configured as described herein to separate the beam of light into multiple light beams, which are directed to focusing optics that include focusing lens 508. The focusing lens focuses the multiple light beams to multiple spots, respectively, on a specimen (not shown in FIG. 5). Common focal plane 510 of the multiple spots is at a tilted angle with respect to (i.e., not perpendicular to) an optical axis of the focusing optics (e.g., axis 504 shown in FIG. 5). The embodiment shown in FIG. 5 may be further configured as described herein.

The spot array layout is defined by two parameters: the spacing between adjacent spots (d) and slant angle of the linear spot array to the optical axis (β). These two parameters determine the grating parameters and the optical parameters.

The spot array slant angle β is determined by the illumination angles,

cos β=sin θ sin ϕ

where θ, ϕ are the polar angle and azimuth angle, respectively. The offset of the axial grating is given by:

y=f tan β

where f is the focal length of the focusing lens.

The axial grating has concentric circular grating groves, and the pitch of the grating varies linearly with the radius. The grating layout can be defined by 2 parameters, wavelength (λ) and focus (z₁) of the first diffracted order. The focus of the first diffraction order is given by:

$${z}_{1} = \frac{f y}{d sin β}$$

Grating pitch as function of offset distance is given by:

$$P ( y ) = \frac{λ f}{d sin β}$$

Grating profile is defined by the number of diffraction orders, and the profile is generally optimized for maximum total diffraction efficiency and maximum uniformity between diffraction orders.

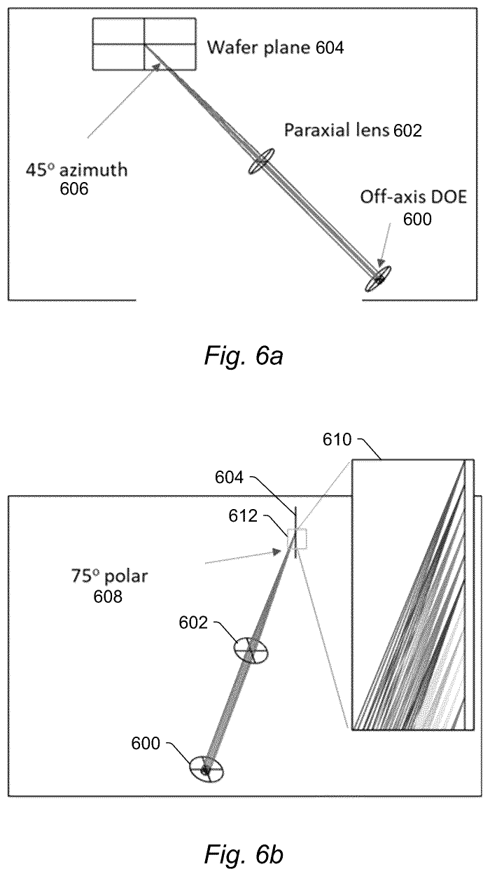

In one embodiment, the multiple spots are each in focus on a surface of the specimen. In another embodiment, the focusing optics are configured to direct the multiple light beams to the multiple spots, respectively, at a polar angle of 75 degrees. A geometrical lens design embodiment for oblique illumination at 75 degree polar angle and 45 degree azimuth angle is shown in FIG. 6a (top view (from wafer surface) of the illumination beam path showing 45 deg azimuthal angle) and FIG. 6b (side view of illumination beam path showing 75 deg polar angle). More specifically, as shown in FIG. 6a, multiple light beams generated by off-axis DOE 600 may be focused onto wafer plane 604 by paraxial lens 602 at azimuthal angle 606 of 45 degrees. In addition, as shown in FIG. 6b, the multiple light beams generated by off-axis DOE 600 may be focused onto wafer plane 604 by paraxial lens 602 at polar angle 608 of 75 degrees. The zoom-in view 610 of focal plane portion 612 shows that all spots are in perfect focus on the wafer even though the wafer surface is at a 75 deg angle with respect to the illumination beam.

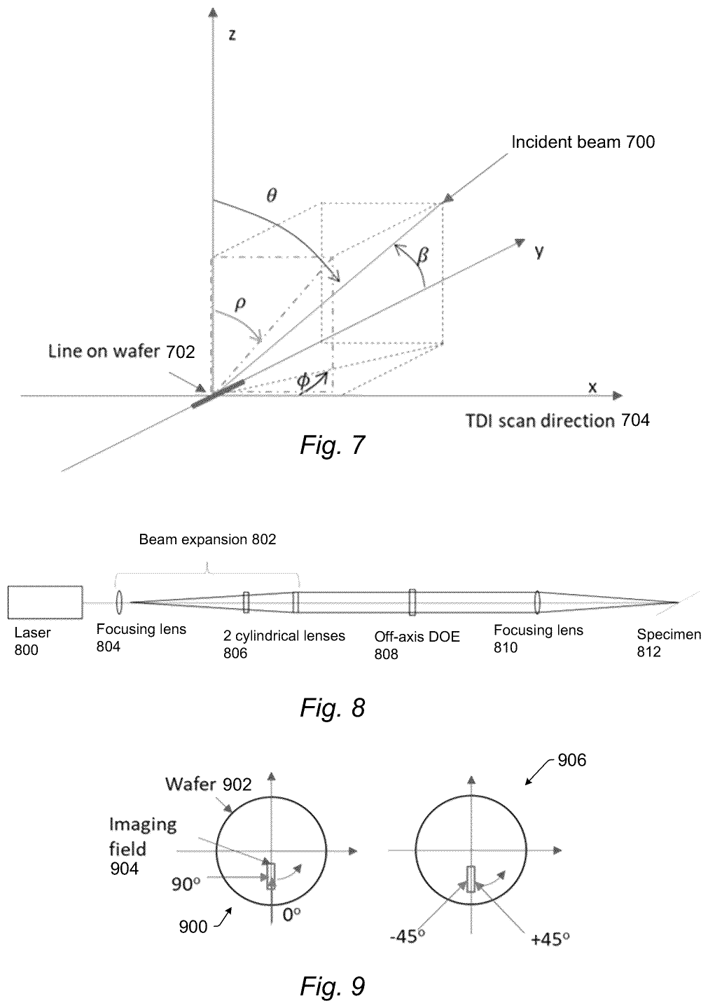

As shown in FIG. 7, the direction of input optical axis in optical design is typically defined as the angle (β) between illumination beam (incident beam 700) and illumination line (line on wafer 702) and the roll angle of incident plane (ρ). The relationship between these two angles to the illumination polar (θ) and azimuthal (ϕ) angles are shown in FIG. 7, and can be determined by the following equations. TDI scan direction 704 is also shown in this figure.

$$\begin{matrix}cos β = sin θsinϕ \\ tan ρ = \frac{sin θ cos ϕ}{cos θ}\end{matrix}$$

One embodiment of the entire illumination optical design is shown in FIG. 8. The output beam from laser 800 is expanded in beam size asymmetrically by beam expansion optics 802 that in this embodiment include focusing lens 804 and 2 cylindrical lenses 806. The beam size is determined by the laser output beam size and the focal lengths of the three lenses. The beam size in the short direction is amplified by a factor of the ratio of the first cylindrical lens to the focusing lens, and the beam size in the short direction is amplified by a factor of the ratio of the second cylindrical lens to the focusing lens. The orientation of the elliptical beam can be controlled by the orientation of the two cylindrical lenses. The expanded beam is then passed through off-axis DOE 808, which has parameters determined by illumination requirements per previous discussions. Then, a linear spot array is formed on the wafer (specimen 812) at the required illumination angles and layout dimensions by focusing lens 810. In this manner, the elements shown in FIG. 8 are configured for transforming and delivering a single laser beam to a slanted spot array on a wafer surface. Other optical elements may be included in the illumination path to control the illumination properties such as waveplate(s) and polarizer(s) and to reduce the footprint and optimize locations of the other optical elements such as fold mirrors.

Dual azimuthal illumination angles provide 1.4× improvement of defect signal-to-noise ratio for film wafers. For example, multiple azimuthal angles of oblique illumination can reduce the speckle noise from wafer surface scattering. A 90 degree difference in azimuthal angles provides the maximum speckle noise reduction. Current implementations use 0 and 90 degree illumination angles, which require two different sets of optics and uneven performances. The illumination optics embodiments described herein can, however, be used for both +45 degree and −45 degree azimuthal illumination. +/−45 degree illuminations simplifies illumination optics (identical optics for both azimuthal angles) and provides uniform performance. For example, a spot array formed at 75 degree polar angle and +/−45 degree azimuthal angles are in perfect focus on the wafer surface thereby providing the maximum uniformity of illumination profile and the maximum depth of focus.

The pros and cons of the two illumination methods are listed in Table 1 and illustrated in FIG. 9. In particular, FIG. 9 shows example 900 of 0 and 90 degree illumination angles used to simultaneously illuminate imaging field 904 on wafer 902 and example 906 of +/−45 degree illumination angles used to simultaneously illuminate the same imaging field on the wafer.

TABLE 1

| | Current method | New method |
|---|---|---|
| Illumination angle | Polar: 75 deg | Polar: 75 deg |
| | Azimuthal: 0° (radial), | Azimuthal: +45°, −45° |
| | 90° (tangential) | |
| Optical axis tilt angle | 75° at 0° | 46° for both |
| | 0° at 90° | |
| Line width elongation | 1x for 0° | 2.7x for both |
| | 3.9x (for 90°) | |
| Illumination optics | Two different sets | Identical |

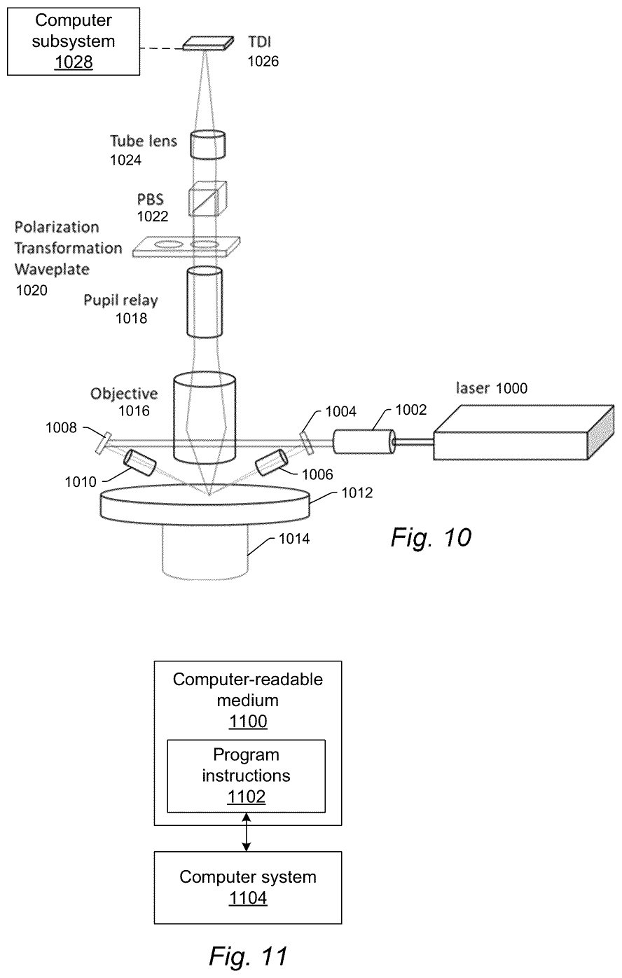

In one embodiment, the system includes beam splitting optics configured for splitting each of the multiple light beams into first and second portions of each of the multiple light beams thereby generating first and second sets of multiple light beams, respectively, and the focusing optics are configured to focus the first and second sets of the multiple light beams to the multiple spots, respectively, on the specimen at different azimuthal angles and the same polar angle. For example, in the embodiment shown in FIG. 10, beam shaping optics 1002 and/or element 1004 described further herein may be configured for splitting each of the multiple light beams generated by beam shaping optics 1002 into first and second portions of each of the multiple light beams thereby generating first and second sets of multiple light beams. Focusing optics 1006 and 1010 (and possibly elements 1004 and 1008) described further herein may be configured to focus the first and second sets of the multiple light beams to the multiple spots, respectively, on specimen 1012 at different azimuthal angles and the same polar angle. Each of these elements may be configured as described further herein.

In one embodiment, the different azimuthal angles are different by 90 degrees. For example, as described above, a particular advantageous set of azimuthal angles are the +/−45 degrees. However, other azimuthal angles are possible in the embodiments described herein such as the 0 and 90 azimuthal angles described above as well as other azimuthal angles that are different by more or less than 90 degrees. In addition, while it may make the most sense to have the azimuthal angles be symmetrical about an x or y axis of the specimen, this is also not required in the embodiments described herein. In general, the azimuthal angles used for inspection may be selected based on the characteristics of the specimen, characteristics of the structures formed on the specimen such as material or composition, dimensions, aspect ratio, orientation, shape, and the like, defects or particles of interest thereon and their various characteristics such as those described above, etc.

In one embodiment of the multi-azimuthal angle configurations (as well as the single azimuthal angle configurations), the system includes a set of cylindrical lenses positioned in the beam of light between the light source and the axial DOE and configured to asymmetrically expand a size of the beam of light. For example, as shown in FIG. 8 and described further above, the output beam from laser 800 may be expanded in beam size asymmetrically by beam expansion optics 802 that in this embodiment include focusing lens 804 and 2 cylindrical lenses 806. As described further above, the beam size and the orientation of the beam are determined by the laser output beam size and the configuration of the three lenses. The expanded and/or shaped beam is then passed through off-axis DOE 808, which is configured as described further herein. In this manner, the system may include a set of cylindrical lenses configured to asymmetrically expand the beam size prior to the beam splitting DOE thereby simplifying the illumination optics for multi-azimuthal illumination.

One embodiment of an implementation of the system configured for generating images of a specimen and/or inspecting a specimen is shown in FIG. 10. This system includes light source 1000 configured to generate a beam of light, which may include a laser or any other suitable light source known in the art. The laser may include any suitable laser known in the art. In addition, one advantage of the embodiments described herein is that by using a 1D spot array to generate a flattop illumination intensity profile, there is no time delay in the system and so the laser can be a cw type laser.

The light beam from the light source may be directed to beam shaping optics 1002, which may include any of the elements (not shown in FIG. 10) described herein. For example, beam shaping optics 1002, may be configured as shown in FIG. 8. In this manner, the beam shaping optics may include at least axial DOE 808 shown in FIG. 8 positioned in the beam of light, and the beam of light is offset to a center of the axial DOE. The axial DOE includes concentric grating rings (e.g., as shown in cross-sectional view 120 in FIG. 1) configured to separate the beam of light into multiple light beams. In addition, beam shaping optics 1002 may be configured for separating each of the multiple light beams into different portions of the light beams that are each focused to the specimen at a different azimuthal angle.

The system also includes focusing optics configured to focus the multiple light beams to multiple spots, respectively, on a specimen, and a common focal plane of the multiple spots is at a tilted angle with respect to an optical axis of the focusing optics. For example, in FIG. 10, the focusing optics may include elements 1004, 1006, 1008, and 1010 in the case of a system that is configured for multiple azimuthal angle illumination. Elements 1004 and 1008 may or may not be part of the focusing optics. These elements may simply be reflective and/or refractive optical elements that direct the different portions of the multiple beams to elements 1008 and 1010, which may be focusing lenses that focus the different portions of the multiple light beams to the multiple spots on specimen 1012. For example, a first portion of each of the multiple light beams may be directed to element 1004, which directs the first portions to focusing optics 1006, and a second portion of each of the multiple light beams may be directed to element 1008, which directs the second portions to focusing optics 1010. In another optional configuration, element 1004 may be configured to perform beam splitting functions. For example, element 1004 may be configured as a beam splitter that allows one portion of each of the multiple beams to pass therethrough to element 1008 and refracts another portion of each of the multiple beams to focusing lens 1006. In this case the two illumination angles can simultaneously illuminate the same area on specimen as long as the beam path length is longer than the coherent length. Element 1004 can also be a switchable element (e.g. a flip-in mirror) that direct the beam to either element 1008 or 1006. In this case the two illumination angles are sequential and wafer is scanned twice with two different azimuthal angles.

In any case, the combination of beam shaping optics 1002, elements 1004 and 1008, and focusing lenses 1006 and 1010 may be configured so that first and second portions of a first of the multiple light beams are directed to the same or substantially the same first area on the specimen at first and second azimuthal angles, respectively, first and second portions of a second of the multiple light beams are directed to the same or substantially the same second area on the specimen (spaced from the first area) at the first and second azimuthal angles, respectively, and so on. In this manner, the elliptically shaped spots on the specimen such as those shown in FIGS. 2 and 3 may each be simultaneously illuminated with different portions of one of the multiple light beams at different azimuthal angles (and the same polar angle).

In another configuration, however, the combination of the beam shaping optics 1002, elements 1004 and 1008, and focusing lenses 1006 and 1010 shown in FIG. 10 may be configured so that first and second portions of a first of the multiple light beams are directed at first and second azimuthal angles, respectively, to different first areas on the specimen spaced from each other, first and second portions of a second of the multiple light beams are directed at the first and second azimuthal angles, respectively, to different second areas on the specimen spaced from each other as well as the different first areas on the specimen, and so on. In this manner, the first portions of each of the multiple light beams may be directed at a first azimuthal angle to a first set of elliptically shaped spots on the specimen that may be configured, for example, as shown in FIGS. 2 and 3, and the second portions of each of the multiple light beams may be directed at a second azimuthal angle to a second set of elliptically shaped spots on the specimen that are spaced from the first set on the specimen and may also be configured, for example, as shown in FIGS. 2 and 3. Therefore, two spatially separated arrays, each including spaced apart, elliptically shaped spots, may be simultaneously illuminated on the specimen at different azimuthal angles (and the same polar angle).

As described further herein, the different azimuthal angles may be different from each other by 90 degrees. For example, the beam shaping optics in combination with the focusing optics may be configured for oblique illumination at +/−45 degree azimuthal angles thereby advantageously generating two effectively uniform flattop line illuminations. In addition, although the +/−45 degree azimuthal angles shown in FIG. 9 may be particularly advantageous for the embodiments described herein, the embodiments may be configured for any other suitable azimuthal angles. For example, the 0 and 90 degrees azimuthal angles may be selected instead of the generally more advantageous +/−45 degree azimuthal angles for detection of some particular defect types. In other words, although the +/−45 degree azimuthal angles are expected to be most advantageous for most of the inspections performed using the systems described herein, the embodiments are not limited to such azimuthal angles.

The system also includes an imaging detector configured to generate an image of the specimen by detecting light from the multiple spots. The light from the each of the illuminated spots on the specimen (e.g., scattered light in the case of DF) may be imaged by objective lens 1016 as shown in FIG. 10. Light collected and imaged by objective lens 1016 may be relayed by pupil relay lens 1018 through one or more polarizing components such as polarization transformation waveplate 1020 and polarizing beam splitter (PBS) 1022. Light exiting the polarizing component(s) may be directed to one or more TDI sensors (shown generically in FIG. 10 as TDI 1026) by tube lens 1024. Each of these elements may have any suitable configuration known in the art. These elements, in combination, form what is commonly referred to in the art as a detection channel. The detection channel may include any other suitable optical elements known in the art such as spectral filters, spatial filters, etc.

The system may be configured to have multiple detection channels (not shown). The multiple detection channels may be configured to detect light from the same illumination spots on the specimen (e.g., one array of spots on the specimen, which may be illuminated at a single azimuthal angle or at multiple azimuthal angles), which are configured in combination with the detector characteristics so that they are “seen” by the detector as an effectively uniform flattop line illumination. Alternatively, when there is more than one array of illuminated spots on the specimen (e.g., different arrays illuminated at different azimuthal angles), one detection channel may be configured for detecting light from a first array of the illuminated spots, and another detection channel may be configured for detecting light from a second array of the illuminated spots. Each of these arrays of the spots may also be configured in combination with the detector characteristics so they are “seen” as different illuminated lines on the specimen, each with an effectively uniform flattop illumination intensity profile.

The multiple detection channels may have various other configurations as well. For example, the detection channels may be configured to detect light scattered from the specimen at different scattering angles and/or polarizations (whether from the same set of spots or different sets of spots). In this manner, different detection channels may be used for different modes of the system, where a “mode” is generally defined as a set of parameters of the system used to generate images for the specimen (other than position at which the images are generated).

The specimen may be scanned in a spiral path (i.e., as in an R-T type scan) to detect defects on the specimen. For example, the system may also include a scanning subsystem (shown generically in FIG. 10 by shaft 1014) configured to cause the light to be scanned over the specimen. A rotation stage (spindle) 1014 may be connected to a linear stage (not shown) on which specimen 1012 is disposed and coupled to any suitable mechanical and/or robotic assembly (not shown) that, in combination, can be configured to move the specimen such that the light can be scanned over the specimen in a spiral track. In addition, or alternatively, the system may be configured such that one or more optical elements perform some scanning of the light over the specimen. The light may be scanned over the specimen in any suitable fashion.

The system also includes computer subsystem 1028 configured to detect defects on the specimen based on the image. Computer subsystem 1028 may be coupled to TDI 1026 in any suitable manner (e.g., via one or more transmission media, which may include “wired” and/or “wireless” transmission media) such that the computer subsystem can receive the images generated by TDI 1026. Computer subsystem 1028 may be configured for detecting defects on specimen 1012 by applying a defect detection method to the images generated by TDI 1026. Detecting defects on the specimen may be performed in any suitable manner known in the art (e.g., applying a defect detection threshold to the output and determining that any output having a value above the threshold corresponds to a defect (or a potential defect)) with any suitable defect detection method and/or algorithm.

The computer subsystem may also be referred to herein as a computer system. The computer subsystem or system may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem or system may also include any suitable processor known in the art such as a parallel processor. In addition, the computer subsystem or system may include a computer platform with high speed processing and software, either as a standalone or a networked tool.

FIG. 10 is provided herein to generally illustrate some configurations of inspection systems in which the axial DOE and other various optical elements may be included. Obviously, the inspection system configurations described herein may be altered to optimize the performance of the system as is normally performed when designing a commercial system. In addition, the systems described herein may be implemented using an existing optical system (e.g., by adding the axial DOE and other functionality described herein to an existing inspection system) such as inspection systems that are commercially available from KLA Corp., Milpitas, Calif. For some such systems, the embodiments described herein may be provided as optional functionality of the existing system (e.g., in addition to other functionality of the system). Alternatively, the system described herein may be designed “from scratch” to provide a completely new system.

In one embodiment, the specimen is a wafer. The wafer may include any wafer known in the semiconductor arts. In addition, although some embodiments may be described herein with respect to a wafer, the embodiments are also not limited in the specimen for which they can be used. For example, the embodiments described herein may be used for specimens such as reticles, flat panels, personal computer (PC) boards, and other semiconductor specimens.

In another embodiment, the system is configured as a metrology system. In a further embodiment, the system is configured as a defect review system. For example, the embodiment of the system shown in FIG. 10 may be modified in one or more parameters to provide different imaging capability depending on the application for which it will be used. In one such example, the system may be configured to have a higher resolution if it is to be used for metrology rather than for inspection. In other words, the embodiment of the system shown in FIG. 10 describes some general and various configurations for an imaging system that can be tailored in a number of manners that will be obvious to one skilled in the art to produce systems having different imaging capabilities that are more or less suitable for different applications.

Computer subsystem 1028 shown in FIG. 10 may be configured to generate results that include at least the information determined for the specimen based on the images generated by the imaging detector possibly with any other output generated by the computer subsystem. The results may have any suitable format (e.g., a KLARF file, which is a proprietary file format used by tools commercially available from KLA, a results file generated by Klarity, which is a tool that is commercially available from KLA, a lot result, etc.). In addition, all of the embodiments described herein may be configured for storing results of one or more steps of the embodiments in a computer-readable storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. to perform one or more functions for the specimen or another specimen.

Such functions include, but are not limited to, altering a process such as a fabrication process or step that was or will be performed on the specimen in a feedback, feedforward, in-situ manner, etc. For example, the computer subsystem may be configured to determine one or more changes to a process that was or will be performed on the specimen based on the detected defect(s) and/or other determined information. The changes to the process may include any suitable changes to one or more parameters of the process. For example, if the determined information is for defects detected on the specimen, the computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown in FIG. 10) accessible to both the computer subsystem and the semiconductor fabrication system. The semiconductor fabrication system may or may not be part of the system embodiments described herein. For example, the systems described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

The embodiments described herein provide a number of important advantages over currently used methods for oblique multi-spot illumination imaging. For example, the embodiments described herein provide a method and apparatus for generating a substantially uniform linear spot array at oblique illumination angles, especially for large polar angle and +/−45 degree azimuth angles. In addition, the number of spots can be relatively large to achieve substantially high illumination efficiency and uniformity. The embodiments described herein also have better tolerance to incident beam quality and to mechanical alignment. Therefore, the embodiments are more cost effective to implement and can maintain long term stability. A further advantage of the embodiments described herein is that the DOE grating pitch can be relatively large due to the substantially small separation angles between beams. As such, DOE manufacture can be readily available. An additional advantage of the embodiments described herein is that the illumination path from laser to wafer is much simpler and more compact, with improved illumination efficiency and footprint. In addition to the simpler design of the embodiments described herein, the embodiments described herein also provide more stable designs.

Each of the embodiments of the systems described above may be further configured according to any other embodiment(s) described herein.

Another embodiment relates to a method for generating an image of a specimen. The method includes separating a beam of light (e.g., light beam 114 shown in FIG. 1) into multiple light beams (124) with an axial DOE (118) positioned in the beam of light. The beam of light is offset to a center of the axial DOE (e.g., as shown in cross-sectional view 120 of the axial DOE and cross-sectional view 120a of light beam 114 showing the relative position of the light beam to the center of the axial DOE). The axial DOE includes concentric grating rings (shown in cross-sectional view 120) configured to separate the beam of light into the multiple light beams. The method also includes focusing the multiple light beams to multiple spots, respectively, on a specimen (e.g., spots 200 shown in FIG. 2). A common focal plane (e.g., 510 shown in FIG. 5) of the multiple spots is at a tilted (i.e., non-perpendicular) angle (6) with respect to optical axis 504 of the multiple light beams. In addition, the method includes generating an image of the specimen by detecting light from the multiple spots (e.g., with TDI sensor 1026 shown in FIG. 10).

Each of the steps of the method may be performed as described further herein. The method may also include any other step(s) that can be performed by the system(s) described herein. The steps of the method may be performed by the systems described herein, which may be configured according to any of the embodiments described herein.

An additional embodiment relates to a non-transitory computer-readable medium storing program instructions executable on a computer system for performing a computer-implemented method for generating an image of a specimen and/or inspecting a specimen. One such embodiment is shown in FIG. 11. In particular, as shown in FIG. 11, non-transitory computer-readable medium 1100 includes program instructions 1102 executable on computer system 1104. The computer-implemented method may include any step(s) of any method(s) described herein.

Program instructions 1102 implementing methods such as those described herein may be stored on computer-readable medium 1100. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 1104 may be configured according to any of the embodiments described herein.

Further modifications and alternative embodiments of various aspects of the invention will be apparent to those skilled in the art in view of this description. For example, methods and systems for generating an image of a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for generating an image of a specimen, comprising:
a light source configured to generate a beam of light;
an axial diffractive optical element positioned in the beam of light, wherein the beam of light is offset to a center of the axial diffractive optical element, and wherein the axial diffractive optical element comprises concentric grating rings configured to separate the beam of light into multiple light beams;
focusing optics configured to focus the multiple light beams to multiple spots, respectively, on a specimen, wherein a common focal plane of the multiple spots is at a tilted angle with respect to an optical axis of the focusing optics; and
an imaging detector configured to generate an image of the specimen by detecting light from the multiple spots.

2. The system of claim 1, wherein a pitch of the grating rings varies with a radius of the axial diffractive optical element.

3. The system of claim 1, wherein the axial diffractive optical element is further configured to function as a combination of a diffractive beam splitter and a Fresnel lens with a weak focusing power of diffraction orders.

4. The system of claim 1, wherein at least two of the multiple light beams have different powers.

5. The system of claim 1, wherein the multiple spots have an elliptical shape with a long axis at an angle with respect to a scan direction of the imaging detector.

6. The system of claim 1, wherein the imaging detector is further configured as a time delay integration camera.

7. The system of claim 1, wherein the multiple spots are separated from each other on the specimen.

8. The system of claim 1, wherein the imaging detector is further configured as a time delay integration camera, and wherein projection of each of the multiple spots onto a field direction of the time delay integration camera, perpendicular to a scan direction of the time delay integration camera, overlaps with projection of one or more of the multiple spots adjacent to said each of the multiple spots onto the field direction.

9. The system of claim 8, wherein a projected distance between said each of the multiple spots and each of the one or more of the multiple spots adjacent to said each of the multiple spots is approximately half a size of the multiple spots.

10. The system of claim 8, wherein the imaging detector is further configured to integrate intensity of the light from the multiple spots in the scan direction.

11. The system of claim 8, wherein a projected overlap of the multiple spots generates a uniform flattop illumination profile.

12. The system of claim 1, wherein the focusing optics are further configured to direct the multiple light beams to the multiple spots, respectively, at a polar angle of 75 degrees.

13. The system of claim 1, further comprising beam splitting optics configured for splitting each of the multiple light beams into first and second portions of said each of the multiple light beams thereby generating first and second sets of multiple light beams, respectively, wherein the focusing optics are further configured to focus the first and second sets of the multiple light beams to the multiple spots, respectively, on the specimen at different azimuthal angles and the same polar angle.

14. The system of claim 13, wherein the different azimuthal angles are different by 90 degrees.

15. The system of claim 13, further comprising a set of cylindrical lenses positioned in the beam of light between the light source and the axial diffractive optical element and configured to asymmetrically expand a size of the beam of light.

16. The system of claim 1, wherein the multiple spots are each in focus on a surface of the specimen.

17. The system of claim 1, wherein the system is further configured for inspection of the specimen.

18. The system of claim 1, wherein the specimen is a wafer.

19. A method for generating an image of a specimen, comprising:
separating a beam of light into multiple light beams with an axial diffractive optical element positioned in the beam of light, wherein the beam of light is offset to a center of the axial diffractive optical element, and wherein the axial diffractive optical element comprises concentric grating rings configured to separate the beam of light into the multiple light beams;
focusing the multiple light beams to multiple spots, respectively, on a specimen, wherein a common focal plane of the multiple spots is at a tilted angle with respect to an optical axis of the multiple light beams; and
generating an image of the specimen by detecting light from the multiple spots.

20. A system configured for inspecting a specimen, comprising:
a light source configured to generate a beam of light;
an axial diffractive optical element positioned in the beam of light, wherein the beam of light is offset to a center of the axial diffractive optical element, and wherein the axial diffractive optical element comprises concentric grating rings configured to separate the beam of light into multiple light beams;
focusing optics configured to focus the multiple light beams to multiple spots, respectively, on a specimen, wherein a common focal plane of the multiple spots is at a tilted angle with respect to an optical axis of the focusing optics;
an imaging detector configured to generate an image of the specimen by detecting light from the multiple spots; and
a computer subsystem configured to detect defects on the specimen based on the image.
